(19) United States
(12) Patent Application Publication
(10) Pub. No.: US 2015/0324738 A1
(43) Pub. Date: Nov. 12, 2015

(54) INVENTORY MANAGEMENT SYSTEM

(71) Applicant: Aldemar Moreno, Houston, TX (US)

(72) Inventor: Aldemar Moreno, Houston, TX (US)

(21) Appl. No.: 14/274,911

(22) Filed: May 12, 2014

(51) Int. Cl. G06Q 10/08

(52) U.S. Cl. CPC G06Q 10/087

(57) ABSTRACT

A method for managing inventory including selecting an item criterion and configuring a scanning device to intercept an item based on the item criterion. Additionally, scanning a plurality of items and determining whether the item includes the item criterion. The method also includes altering a user if the item includes the item criterion and preventing the user from scanning a second item if the first item includes the item criterion.

### BACKGROUND OF THE INVENTION

In the shipping and the retail industries, packages or products move from location to location on a regular basis. In the shipping industry, a shipping order may be placed at a first location and sent from a second location. In such a scenario, a package may be sent from the second location directly to the first location or, because of logisitics, sent from the second location to the first location by way of several intermediate locations. Because of the number of locations that a package may transfer between en route from a sending location to a receiving location, the package may inadvertently be delayed during the shipping process.

When a package is delayed during the shipping process, the efficiency of the process is decreased, which may result in lost revenue, lost sales, and customer dissatisfaction. Additionally, in certain circumstances, packages may inadvertently be lost at one of the shipping locations. Because current inventory management systems do not provide an effective tracking means for locating lost packages, the shipping company may be responsible for the cost of the lost package. Even in instances where the package is not lost, if a package remains at a shipping location for a longer period of time than expected, the shipping company may be required to refund the shipping fee, replace the delayed item, or otherwise compensate a consumer.

In addition the inefficiencies in the shipping industry, the retail industry moves product between areas of a facility on a regular basis. For example, in the retail industry items may be stocked on a shelf following a particular protocol, such as first in first out. This system theoretically allows items that are shipping to the store first to be sold first. Inventory management systems such as this are especially important in retail industries that sell perishable goods, such as the grocery and/or the pharmaceutical industries. In such industries, expired items are often thrown away or otherwise disposed of resulting in lost profitability for the retailer. Additionally, when expired products are not sold in time, or otherwise removed from the shelf, a consumer may purchase and consume the item, potentially resulting in health consequences.

While retailers attempt to sell products by a required sell-by date, in many instances expired products are not removed from the shelf and/or products with a longer shelf life remain on the shelf while newer products are sold first. Such inefficiencies may result in lost profitability to the retailer and may ultimately result in higher overall costs being passed down to the consumer.

Some shipping companies and retailers attempt to prevent ineffective inventory management through the use of automated sorting systems, telecoding systems, tracking systems, and the like. However, such systems are prohibitively expensive in many industries, and as such, inventory management systems are often not used.

### BRIEF SUMMARY OF THE INVENTION

According to one aspect of one or more embodiments of the present invention, a method for managing inventory includes selecting an item criterion and configuring a scanning device to intercept an item based on the item criterion. Additionally, scanning a plurality of items and determining whether the item includes the item criterion. The method also includes altering a user if the item includes the item criterion and preventing the user from scanning a second item if the first item includes the item criterion.

According to one aspect of one or more embodiments of the present invention, a method for managing inventory includes selecting an item criterion including a facility time and configuring a scanning device to intercept an item based on the facility time criterion. Additionally, scanning a plurality of items and determining whether the item includes the facility time criterion. The method also includes altering a user if the item includes the facility time criterion and preventing the user from scanning a second item if the first item includes the facility time criterion.

According to one aspect of one or more embodiments of the present invention, a system for managing inventory includes a scanning device that is configured to determine an item criterion and a plurality of items including an item tag. Also, wherein the item tag includes item criterion, wherein the scanning device is configured to alert a user if a scanned item includes the item criterion, and wherein the scanning device is configured to prevent the user from scanning additional items if the item includes the item criterion.

Other aspects of the present invention will be apparent from the following description and claims.

### BRIEF DESCRIPTION OF THE DRAWINGS

FIG. 1 shows a method in accordance with one or more embodiments of the present invention.

FIG. 2 shows a device in accordance with one or more embodiments of the present invention.

FIG. 3 shows a schematic system overview in accordance with one or more embodiments of the present invention.

### DETAILED DESCRIPTION OF′ THE INVENTION

One or more embodiments of the present invention will now be described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

The shipping and retail industries have conventionally had issues with delayed packages and expired products, as described in detail above. For clarity in describing the present invention, the shipping industry and retail industries application of the present disclosure are described independently.

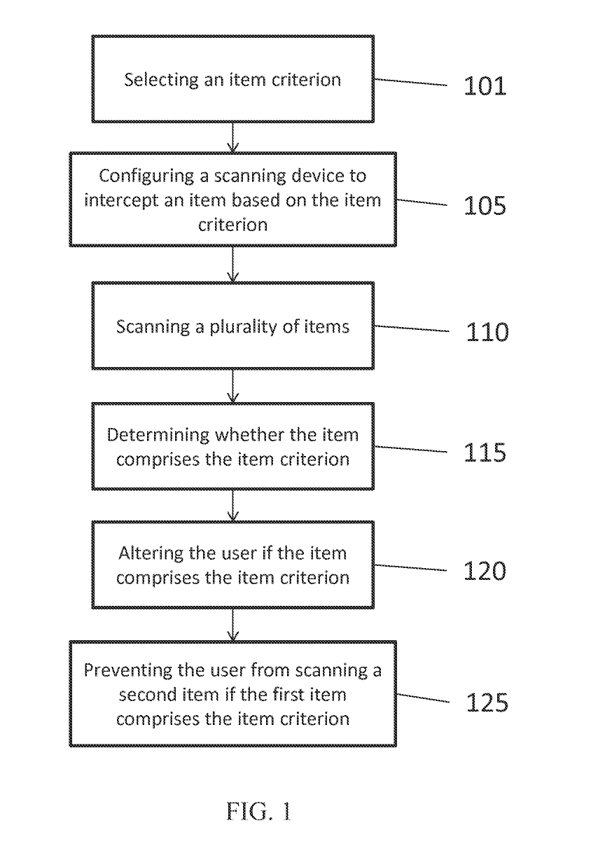

Referring initially to FIG. 1, a block diagram of a method of inventory management according to aspects of the present disclosure is shown. In the first embodiment, a method of managing inventory of a shipping industry is discussed.

In this embodiment, a shipping company has an interest in shipping packages between multiple locations as quickly as possible. As discussed above, during the shipping process, an order may be placed from a first location and the order may be fulfilled at a second location. As such, the package may be shipped from the second location with a final destination of the first location, or a different final destination as defined in the order. In such a situation it is possible that the package will be picked up and shipped substantially directly from the second location to the first location or other final destination. However, because of the logistics of multiple shipping nodes and methods of transportation (e.g., over land, air, and sea), it is often the case that the package will be shipped between multiple locations or nodes. Thus, it commonly occurs that the product will leave the second destination and prior to final delivery be transported to a number of destinations before being delivered to the final destination.

When packages are shipped to multiple locations prior to final delivery, there is an opportunity at each location for the product to be lost or otherwise delayed. In order to decrease the amount of time a product spends at a particular location, as well as to decrease the amount of packages lost during the process, a method of inventory management that allows the time the product spends at a particular location to be obtained is desirable.

During the shipping process, an originator places an order for a product or initiates a shipping protocol. The shipping protocol may include ordering an item, mailing an item, or otherwise causing a package, or item, to be transported from a first location to a second location. When the item is received by the shipper at a first location the shipper typically tags the item with an identifier that allows the shipper and the receiver to track the item during the shipping process. As such, a shipper or receiver may be able to determine where the item is during the shipping process. For example, a shipper may tag an item with date and item information that allows the shipper and/or receiver to determine how long it will take the item to reach a destination. This information is commonly referred to as tracking data. While the tracking data is useful in determining where a product is in the shipping process, the tracking data does not control the item during the shipping process. Said another way, the tracking data may tell a shipper or receiver where the item is in the shipping process, but it does not prevent an item from remaining for a specified time at a particular location. The shipping data is merely informative data that is used to determine the location of a shipped item.

In order to prevent an item from remaining for an undesirable amount of time at a particular location during the shipping process, additional item information is required. The additional information and method for managing the items during the shipping process are described in greater detail below with respect to FIG. 1.

Referring specifically to FIG. 1, when an item is initially shipped, the item is deposited in the custody of a shipper at a shipping facility. In order to prevent an item from being lost or otherwise delayed during the shipping process, the shipper may internally track and manage the item.

Once received at the shipping location, and the shipping process has started, the shipper may select a criterion 101 in order to manage the item. The shipping criterion may include various information including, for example, a date, an origination date, an expiration date, a final destination location, information about the item, etc. The item criterion may be selected based on the requirements of the shipping operation, the requirements of the shipper, the requirements of the receiver, the requirements of the originator, or other requirements as desired by one or more parties subject to the shipping arrangement.

The item criterion may subsequently be used to determine a property of the shipped item during the shipping process. For example, the shipper may want to prevent an item from remaining too long in a particular location. In other situations, the shipper may want to determine how long an item has remained in a particular location to insure that the item is not being delayed during transit.

After the item criterion is selected 101, a user may configure a scanning device to intercept an item based on item criterion 105. The scanning device may include, for example, computer based systems, handheld systems, scanners, and the like. Scanning devices and systems that may be used in this method are discussed in detail below. For the purpose of the embodiment described herein, a user may use a handheld scanning device to scan packages. Configuring the scanning device 105 may include entering information into the scanning device in order to identify particular item criterion. For example, in one embodiment, a user may configure the scanning device to determine how long an item has been at a particular location. The scanning device may further be configured to determine whether the item has been at the location for a preselected period of time. In one embodiment, the scanning device may be configured to determine whether the item has been at the location for more than 24 hours. In other embodiments, the scanning device may be configured to determine whether the item has been at the location for more than 36 hours, more than 48 hours, more than 72 hours, or any other time period desired by the shipper or other applicable party.

After the scanning device is configured to intercept the item based on the item criterion 105, the user may scan a plurality of items 110. As used herein, the scanning of the plurality of items 110 may include manually scanning the items with the scanning device, passing the items through a system that automatically scans the items, etc. Scanning the items may further include interpreting the item criterion, which may be stored on the item as item data as, for example, a universal product code, proprietary tracking data, proprietary item information, radio frequency tags, and the like.

During the scanning of the plurality of items 110, the scanning device, or a computer connected thereto may interpret the item data in order to determine whether the item criterion that has been previously selected 115, is present. The step of determining whether the item includes the item criterion 115 may include interpreting the item data. Interpreting the item data may further include comparing the item data with the selected item criterion 101 in order to determine whether the item criterion 115 is met. For example, in one embodiment, an item criterion of time at location may be selected. Furthermore, the item criterion may be specified as more than 24 hours. When the item is scanned 110, the scanning device may be configured to determine whether the item has been at the particular location for less or more than 24 hours. Similarly, an item criterion 101 may be specified as more than 48 hours. In such a situation, the scanning device may be configured 105 to determine whether the item has been at the particular location for more than 48 hours. Those of ordinary skill in the art will appreciate that depending on the requirements of the shipping operation, various time periods may be selected in order to determine whether an item has been at a particular location for greater than a particular period of time.

If the item has been at the particular location for greater than the period of time, as identified by the scanning device, the scanning device may be configure to alert the user that the item includes the item criterion 115 as part of its item data 120. Alternatively, the user may include various forms of alerts including, for example, auditory, visual, tactile, and other types of alerts that would be appreciated by those skilled in the art.

In one embodiment, the alert may include a single auditory note if the item does include the item criterion, in another embodiment the alert may include a substantially continuous auditory note if the item does not include the item criterion 115. Depending on the settings of the scanning device, the alert may further include a visual and/or tactile response depending on whether the item includes or does not include the item criterion 115.

In one embodiment, if the item includes the item criterion 115, the user may be prevented from scanning another item 125. For example, if the item has been in the facility for more than 24 hours, the user may be prevented from scanning another, second item, until the alert is abated. In such a circumstance, the user is thus alerted that the item has been at the location for more than the allotted period of time (i.e., 24 hours), and some remedial action may be taken. Depending on the situation, the remedial action may include, removing the item from the shipping process, rerouting the item in the shipping process, prioritizing the item, or otherwise accepting the alert and moving on to another item. In any case, the user has been alerted that there is an inefficiency in the shipping process and has been provided the information required to remediate the situation.

In certain embodiments, additional steps may be taken in order to further increase the efficiency of the shipping process. For example, in one embodiment, after the user is alerted 120, the user may retrieve the item, and the scanning device may provide feedback to the user. The provided feedback may include, for example, item information data that may include information about the item, information about the shipping, information about receipt time, date, etc.

Additionally, when the user scans the item, the scanning device may display information to the user including, for example, shipping data, expiration data, date data, time, data, etc.

Furthermore, in certain embodiments, it may be required that the user consult a manager prior to overriding the alert. In such a situation, it may be necessary for the user or manager to enter certain information into the scanning device in order to override the alert prior to scanning additional items. In certain situations, it may also be necessary for the item to be removed from the normal shipping process in order to correct the delay in shipping.

Still referring to FIG. 1, in certain embodiments, the method described herein may be used in the retail industry to prevent items from remaining on the shelf too long and expiring or otherwise rendered unsalable.

In a retail environment, it may be beneficial to track and monitor the expiration status of consumer goods. In order to fully explain how methods and systems of the present invention may be used in a retail environment, the following example of methods of inventory management as applied in a grocery store environment are discussed in detail below.

When items are brought into a grocery store, many items have an expiration date or a suggested sale by date. Such items may be tagged with item data that may include, for example, an expiration date or a sale by date. Such items may be tagged with, for example, a universal product code, proprietary tracking data, proprietary item information, radio frequency tags, and the like.

In order to help prevent items from expiring or otherwise becoming unsaleable, a user at the retail store may select an item criterion 101. The item criterion may include, for example, an expiration date, a sell by date, a use by date, a best by date, or other criterion that may enable a user to track the usability of the item. In certain situations, a user may select multiple item criterions on which to determine an items usability. For example, a user may choose to select an item criterion that is based on both an expiration date and how long until the expiration date occurs. In such a situation, the selected item criterion may include both the expiration date and a time interval, such as 24 hours, in order to alert the user if an item is set to expire in less than 24 hours. Those of ordinary skill in the art will appreciate that in certain circumstances the time sequencing may vary. For example, a user may select an item criterion that identifies items that expire within 24 hours, 24 hours, 36 hours, 72 hours, or any other time interval. The selected item criterion may be based on the type of item that is being identified. For example, perishable items may have a substantially smaller expiration period, such as 24 hours, while non-perishable goods may have a relatively longer expiration period, such as several months or years. Thus, the selected criterion 101 may vary widely depending on the type of good that is being scanned.

After the user selects the item criterion 101, the user may then configure a scanning device to intercept items based on the item criterion 105. As explained above, the scanning device may include various types of devices such as, for example, computer based systems, handheld systems, scanners, and the like. Configuring the scanning device 105 may include programming the scanning device with the selected item criterion, selecting the item criterion from a pre-configured set of options, and/or selecting a custom option.

After the scanning device is configured with the selected item criterion 105, the user may scan a plurality of items 110. For example, in a grocery store, the user may scan all of the items in a certain section in order to determine if any items are expired or are set to expire within a certain amount of time. If, for example, the user is in the dairy section of a grocery store, the user may scan all of the milk products in order to determine when a certain product expires.

As the user scans the milk products, the scanning device determines whether the particular product includes the item criterion 115. In the present example, when the selected criterion is an expiration date within 24 hours, as the user scans the items, the scanning device will determine whether the item is set to expire within 24 hours. If the item is set to expire within 24 hours, the scanning device will alert the user that the item includes the item criterion 120. Said another way, in the present example, if the user scans a milk product that is set to expire within 24 hours, the user is alerted through, fir example, an audible note, a visual cue, a tactile identifier, or the like. The user is then prevented from scanning another item if the first item includes the item criterion 125. If the user locates an item that is set to expire within 24 hours, the user may then choose a remedial action, such as removing the product from the shelf, relocating the product into a position to be sold more quickly, discounting the item for short sale, or perform another action as may be available depending on the type of product and the expiration date of the product.

Those of ordinary skill in the art will appreciate that the above described method may be applied to a variety of goods in the retail industry. For example, in addition to grocery stores, the method may be used in the pharmaceutical industry to monitor the expiration status of pharmaceutical products, in the culinary industry to monitor the expiration status of perishable goods, in the energy industry to monitor the expiration status of hydrocarbon fluids, in the horticulture industry to monitor the viability of plants, and in various other industries as may be appreciated by those of ordinary skill in the art.

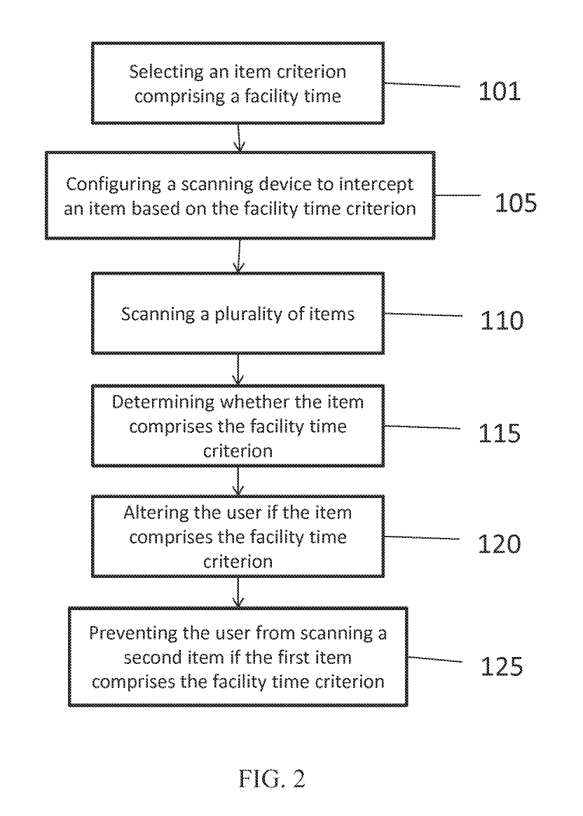

In addition to the above-described methods ability to monitor the expiration status of products in the retail industry, as well as the ability to manage shipping inventory, the method described herein may also be used to monitor how long an item has been in a particular inventory. Methods of monitoring how long an item has been in inventory are described in detail below with respect to FIG. 2.

Referring to FIG. 2, when an item is initially shipped, the item is deposited in the custody of a shipper at a shipping facility. In order to prevent an item from being lost or otherwise delayed during the shipping process, the shipper may internally track and manage the item.

Once received at the shipping location, and the shipping process has started, the shipper may select a criterion 101 in order to manage the item. The shipping criterion may include various information including, for example, a facility time that may represent the time or date at which the item entered the inventory at a particular location. The item criterion may be selected based on the requirements of the shipping operation, the requirements of the shipper, the requirements of the receiver, the requirements of the originator, or other requirements as desired by one or more parties subject to the shipping arrangement.

The item criterion may subsequently be used to determine a property of the shipped item during the shipping process. In the present example, wherein the item criterion includes a facility time, the property that is monitored may include how long an item has been in the inventory at a particular shipping location. As such, a user may subsequently monitor all items, or a subset of selected items, in order to track how long the items have been in the inventory at a particular location.

After the item criterion is selected 101, a user may configure a scanning device to intercept an item based on the item criterion of facility time 105. The scanning device may include, for example, computer based systems, handheld systems, scanners, and the like. Scanning devices and systems that may be used in this method are discussed in detail below. For the purpose of the embodiment described herein, a user may use a handheld scanning device to scan packages. Configuring the scanning device 105 may include entering information into the scanning device in order to identify particular item criterion of facility time. In this particular embodiment, a user may configure the scanning device to determine how long an item has been at a particular location. The scanning device may further be configured to determine whether the item has been at the location for a preselected period of time. In one embodiment, the scanning device may be configured to determine whether the item has been at the location for more than 24 hours. In other embodiments, the scanning device may be configured to determine whether the item has been at the location for more than 36 hours, more than 48 hours, more than 72 hours, or any other time increment desired by the shipper or other applicable party.

After the scanning device is configured to intercept the item based on the item criterion of facility time 105, the user may scan a plurality of items 110. As used herein, the scanning of the plurality of items 110 may include manually scanning the items with the scanning device, passing the items through a system that automatically scans the items, etc. Scanning the items may further include interpreting the item criterion of facility time, which may be stored on the item as item data as, for example, a universal product code, proprietary tracking data, proprietary item information, radio frequency tags, and the like.

During the scanning of the plurality of items 110, the scanning device, or a computer connected thereto may interpret the item data in order to determine whether the item criterion of facility time 115, is present. The step of determining whether the item includes the item criterion of facility time 115 may include interpreting the item data. Interpreting the item data may further include comparing the item data with the selected item criterion of facility time 101 in order to determine whether the item criterion are met. In this embodiment, the item criterion of facility time may be specified as defining a particular time the item has been in the facility. When the item is scanned 110, the scanning device may be configured to determine whether the item has been at the particular location for more or less than 24 hours. Similarly, an item criterion may be specified as more than 48 hours. In such a situation, the scanning device may be configured to determine whether the item has been at the particular location for more or less than 48 hours. Those of ordinary skill in the art will appreciate that depending on the requirements of the shipping operation, various time increments may be selected in order to determine whether an item has been at a particular location for greater than a particular period of time.

If the item has been at the particular location for greater than the period of time, as identified by the scanning device, the scanning device may be configure to alert the user that the item includes the item criterion of facility time as part of its item data 120. Altering the user may include various forms of alerts including, for example, auditory, visual, tactile, and other types of alerts that will be appreciated by those skilled in the art.

In one embodiment, the alert may include a single auditory note if the item does include the item criterion of facility time. In another embodiment the alert may include a substantially continuous auditory note if the item does not include the item criterion of facility time. Depending on the settings of the scanning device, the alert may further include a visual and/or tactile response depending on whether the item includes or does not include the item criterion of facility time.

In one embodiment, if the item includes the item criterion of facility time, the user may be prevented from scanning another item 125. For example, if the item has been in the facility for more than 24 hours, the user may be prevented from scanning another, second item, until the alert is abated. In such a circumstance, the user is alerted that the item has been at the location for more than the allotted period of time (i.e., 24 hours), and some remedial action should be taken. Depending on the situation, the remedial action may include, removing the item from the shipping process, rerouting the item in the shipping process, or otherwise accepting the alert and moving on to another item. In any case, the user has been alerted that there is inefficiency in the shipping process and has been provided the information required to remediate the situation.

In certain embodiments, additional steps may be taken in order to further increase the efficiency of the shipping process. For example, in one embodiment, after the user is alerted 120, the user may retrieve the item, and the scanning device may provide feedback to the user. The provided feedback may include, for example, item information data that may include information about the item, information about the shipping, information about receipt time, date, etc.

Additionally, when the user scans the item, the scanning device may display information to the user including, for example, shipping data, expiration data, date data, time, data, etc.

Furthermore, in certain embodiments, it may be required that the user consult a manager prior to overriding the alert. In such a situation, it may be necessary for the user or manager to enter certain information into the scanning device in order to override the alert prior to scanning additional items. In certain situations, it may also be necessary for the item to be removed from the normal shipping process in order to correct the delay in shipping.

As explained above, methods of the present invention may use scanning devices that include computing systems. Scanning devices that are used according to the present invention may include handheld devices, laptops, tablets, portable computing systems, stand-alone computing systems, desktop computing systems, and other computing systems as will be appreciated by those of ordinary skill in the art. A general computing system, including exemplary computing system components is described in greater detail below.

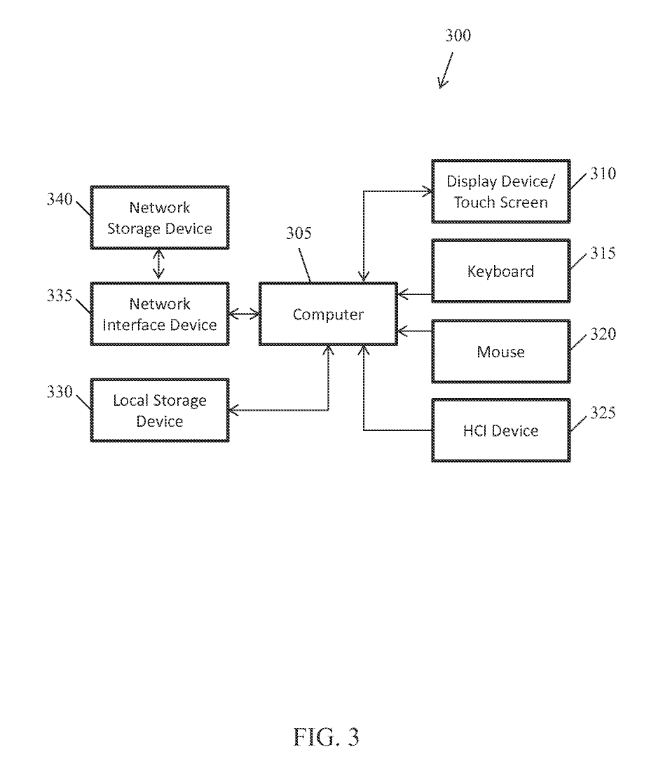

FIG. 3 shows a computing system 300 in accordance with one or more embodiments of the present invention. Computing system 300 may include one or more computers 305 that each includes one or more printed circuit boards (not shown) or flex circuits (not shown) on which one or more processors (not shown) and system memory (not shown) may be disposed. Each of the one or more processors (not shown) may be a single-core processor (not shown) or a multi-core processor (not shown). Multi-core processors (not shown) typically include a plurality of processor cores (not shown) disposed on the same physical die or a plurality of processor cores (not shown) disposed on multiple die that are disposed in the same mechanical package. Computing system 300 may include one or more input/output devices such as, for example, a display device 310, keyboard 315, mouse 320, and/or any other human-computer interface device 325. The one or more input/output devices may be integrated into computer 305. Display device 310 may be a touch screen that includes a touch sensor (not shown) configured to sense touch. A touch screen enables a user to control various aspects of computing system 300 by touch or gestures. For example, a user may interact directly with objects depicted on display device 310 by touch or gestures that are sensed by the touch sensor and treated as input by computer 305.

Computing system 300 may include one or more local storage devices 330. Local storage device 330 may be a solid-state memory device, a solid-state memory device array, a hard disk drive, a hard disk drive array, or any other non-transitory computer readable medium. Local storage device 330 may be integrated into computer 305. Computing system 300 may include one or more network interface devices 340 that provide a network interface to computer 305. The network interface may be Ethernet, Wi-Fi, Bluetooth, WiMAX, Fibre Channel, or any other network interface suitable to facilitate networked communications. Computing system 300 may include one or more network-attached storage devices 340 in addition to, or instead of, one or more local storage devices 330. Network-attached storage device 340 may be a solid-state memory device, a solid-state memory device array, a hard disk drive, a hard disk drive array, or any other non-transitory computer readable medium. Network-attached storage device 350 may not be collocated with computer 305 and may be accessible to computer 305 via one or more network interfaces provided by one or more network interface devices 335. One of ordinary skill in the art will recognize that computer 305 may be a server, a workstation, a desktop, a laptop, a netbook, a tablet, a smartphone, a mobile device, and/or any other type of computing system in accordance with one or more embodiments of the present invention.

Scanning devices used in accordance with embodiments of the present disclosure may operate in a variety of ways. In one embodiment, a scanning device may interpret data by scanning a visual representation on packages or retail goods. Examples of visual representations may include, for example, a universal product code, an international article number, a European article number, global trade item numbers, or other barcode based symbology. In other embodiments, a scanning device may interpret data through radio-frequency identification. Through the use of radio-frequency identification, radio-frequency electromagnetic fields are used to transfer data from a tag on a package or good to the scanning device. Those of ordinary skill in the art will appreciate that in addition to barcode symbology and radio-frequency identification other types of automatic identification data capture may also be used. For example, the scanning device, may be configured to interpret magnetic stripes, optical characters, smart cards, and/or voice recognition. Thus, the scanning device may be used to obtain external data from packages or retails goods through images, sounds, videos, and the like.

Systems that use computing systems, such as those described above may be used to manage inventory according to methods of the present invention. In certain embodiments, the system may include a scanning device, such as a computing system described above, and may be configured to determine an item criterion. The item criterion may be any item criterion described above including, for example, an expiration date and/or a facility time. The system further includes a plurality of items having item tags. The item tags may include, for example, radio frequency tags, universal product codes, or proprietary inventory tags that include particular item data, such as, for example, an expiration date, a facility time, or other information that identifies the item.

In addition to the item tag including the item criterion the scanning device is configured to alert a user if a scanned item includes particular item criterion, and the scanning device may be further configured to prevent a user from scanning additional items if the first scanned item includes particular item criterion.

Advantages of one or more embodiments of the present invention may include one or more of the following:

In one or more embodiments of the present invention, inventory management systems in accordance with the present invention at a shipping company may be improved, thereby allowing packages to transfer more efficiently between multiple transportation facilities.

In one or more embodiments of the present invention, more efficient inventory management at shipping companies may result in increased revenue, decreased insurance costs, faster shipping times, and less package loss.

In one or more embodiments of the present invention, inventory management systems in accordance with the present invention at retail locations may be improved, thereby allowing stock to be sold in a more efficient order.

In one or more embodiments of the present invention, more efficient inventory management at retail establishments may result in increased revenue, decreased insurance costs, less product loss, and decreased health concern instances.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A method for managing inventory comprising:
selecting an item criterion;
configuring a scanning device to intercept an item based on the item criterion;
scanning a plurality of items;
determining whether the item comprises the item criterion;
alerting a user if the item comprises the item criterion; and
preventing the user from scanning a second item if the first item comprises the item criterion.

2. The method of claim 1, further comprising:
allowing the user to scan the second item if the first item does not comprise the item criterion.

3. The method of claim 1, further comprising:
retrieving the item; and
providing feedback to the scanning device, wherein the feedback comprises item information data.

4. The method of claim 1, wherein the item criterion comprises shipping data.

5. The method of claim 1, wherein the item criterion comprises expiration data.

6. The method of claim 1, wherein the altering comprises an audible alter.

7. The method of claim 1, further comprising:
displaying at least one of shipping data and expiration data for the scanned item.

8. The method of claim 1, wherein the altering the user is a single audible note if the item does not comprise the item criterion and wherein the altering the user is a substantially continuous audible note if the item comprises the item criterion.

9. The method of claim 1, wherein the altering the user is a single audible note if the item does comprises the item criterion and wherein the altering the user is a substantially continuous audible note if the item does not comprise the item criterion.

10. The method of claim 1, wherein additional items cannot be scanned until the user overrides the alert.

11. A method for managing inventory comprising:
selecting an item criterion comprising a facility time;
configuring a scanning device to intercept an item based on the facility time criterion;
scanning a plurality of items;
determining whether the item comprises the facility time criterion;
alerting a user if the item comprises the facility time criterion; and
preventing the user from scanning a second item if the first item comprises the facility time criterion.

12. The method of claim 11, further comprising:
allowing the user to scan the second item if the first item does not comprise the facility time criterion.

13. The method of claim 11, further comprising:
retrieving the item; and
providing feedback to the scanning device, wherein the feedback comprises item information data.

14. The method of claim 11, wherein additional items cannot be scanned until the user overrides the alert.

15. The method of claim 11, wherein the facility time criterion comprises an amount of time the item has been in a facility.

16. The method of claim 11, wherein the facility time criterion comprises an arrival time.

17. The method of claim 11, wherein the facility time criterion comprises an expiration time.

18. A system for managing inventory, the system comprising
a scanning device configured to determine an item criterion;
a plurality of items comprising an item tag;
wherein the item tag comprise item criterion;
wherein the scanning device is configured to alert a user if a scanned item comprises the item criterion; and
wherein the scanning device is configured to prevent the user from scanning additional items if the item comprises the item criterion.

19. The method of claim 18, wherein the scanning device is configured to accept a user override after altering the user an item comprises the item criterion.

20. The method of claim 19, wherein the item criterion comprises at least one of an arrival time and an expiration time.
